(19) United States
(12) Patent Application Publication
(10) Pub. No.: US 2025/0191021 A1
(43) Pub. Date: Jun. 12, 2025

(54) SYSTEMS AND METHODS FOR LOYALTY POINTS BORROWING

(71) Applicant: JPMORGAN CHASE BANK, N.A., New York, NY (US)

(72) Inventors: Brian J. SMYTH, West Chester, PA (US); Greg STRANZ, Kennett Square, PA (US); Andrew M. COLLINS, Philadelphia, PA (US)

(21) Appl. No.: 18/965,852

(22) Filed: Dec. 2, 2024

Related U.S. Application Data
(60) Provisional application No. 63/607,853, filed on Dec. 8, 2023.

(51) Int. Cl. G06Q 30/0226; G06Q 30/0207

(52) U.S. Cl. CPC G06Q 30/0233; G06Q 30/0224

(57) ABSTRACT

A method may include: receiving from a user computer program, a selection of a good or service to purchase from a good/service provider using loyalty points and an identification of a date for an event associated with a purchase; determining that the user does not have sufficient loyalty points in a user loyalty point account for the purchase; predicting a predicted number of loyalty points that the user will earn before the date of the event; approving the purchase and borrowing loyalty points necessary for the purchase; conducting the purchase using loyalty points in the user loyalty point account and the borrowed loyalty points; periodically reducing a borrowed loyalty points balance against new loyalty points earned by the user by redeeming the new loyalty points; determining at the date of the event, a final loyalty points deficiency; and executing a transaction to pay for the final loyalty points deficiency.

### RELATED APPLICATIONS

This application claims priority to, and the benefit of, U.S. Provisional Patent Application Ser. No. 63/607,853, filed Dec. 8, 2023, the disclosure of which is hereby incorporated, by reference, in its entirety.

### BACKGROUND OF THE INVENTION

### 1. Field of the Invention

Embodiments are generally directed to systems and methods for loyalty point borrowing.

### 2. Description of the Related Art

Users often wish to purchase goods or services in the future with loyalty points even though they currently do not have sufficient points available to cover the cost. For example, a user may anticipate that before the good or service, such as a flight, a hotel, a rental car, etc. is used, the user will accumulate enough points to cover the balance. Sometimes users are successful and accumulate the points; other times, however, they do not accumulate the required number of points, meaning that their purchase may be cancelled. In addition, if the user waits until the user has enough points, the good or service may no longer be available at the usage date and may be priced very differently than the current price.

### SUMMARY OF THE INVENTION

Systems and methods for loyalty point borrowing are disclosed. In one embodiment, a method may include: (1) receiving, by a points borrowing computer program and from a user computer program associated with a user, a selection of a good or service to purchase from a good/service provider using loyalty points and an identification of a date for an event associated with a purchase; (2) determining, by the points borrowing computer program, that the user does not have sufficient loyalty points in a user loyalty point account for the purchase; (3) predicting, by the points borrowing computer program, a predicted number of loyalty points that the user will earn before the date of the event; (4) approving, by the points borrowing computer program, the purchase and borrowing loyalty points necessary for the purchase; (5) conducting, by the points borrowing computer program, the purchase using loyalty points in the user loyalty point account and the borrowed loyalty points; (6) periodically reducing, by the points borrowing computer program, a borrowed loyalty points balance against new loyalty points earned by the user by redeeming the new loyalty points; (7) determining, the points borrowing computer program and at the date of the event, a final loyalty points deficiency; and (8) executing, by the points borrowing computer program, a transaction to pay for the final loyalty points deficiency.

In one embodiment, a current loyalty point price for the good or service is less than a future loyalty point price for the good or service on the date of the event.

In one embodiment, the good or service is to be provided at a later date.

In one embodiment, the good or service comprises hotel stay, an airline ticket, or a concert ticket.

In one embodiment, the points borrowing computer program predicts the predicted number of loyalty points that the user will earn before a cut-off date before the date of the event.

In one embodiment, the loyalty points are borrowed from a loyalty points pool.

In one embodiment, a balance in the user loyalty point account is reduced by a number of borrowed loyalty points.

In one embodiment, a number of the borrowed loyalty points is based on a loyalty points earning history for the user.

According to another embodiment, a method may include: (1) receiving, by a points borrowing computer program and from a user computer program associated with a user, an identification of a number of loyalty points to borrow and a date of repayment for borrowed loyalty points; (2) predicting, by the points borrowing computer program, a predicted number of loyalty points that the user will earn before the date of repayment; (3) transferring, by the points borrowing computer program, the borrowed loyalty points to a user loyalty points account; (4) periodically reducing, by the points borrowing computer program, a borrowed loyalty points balance against new loyalty points earned by the user by redeeming the new loyalty points; (5) determining, the points borrowing computer program and at the date of the repayment, a final loyalty points deficiency; and (6) executing, by the points borrowing computer program, a transaction to pay for the final loyalty points deficiency.

In one embodiment, the loyalty points are borrowed from a loyalty points pool.

In one embodiment, a number of the borrowed loyalty points is based on a loyalty points earning history for the user.

According to another embodiment, a non-transitory computer readable storage medium may include instructions stored thereon, which when read and executed by one or more computer processors, cause the one or more computer processors to perform steps comprising: receiving, from a user computer program associated with a user, a selection of a good or service to purchase from a good/service provider using loyalty points and an identification of a date for an event associated with a purchase; determining that the user does not have sufficient loyalty points in a user loyalty point account for the purchase; predicting a predicted number of loyalty points that the user will earn before the date of the event; approving the purchase and borrowing loyalty points necessary for the purchase; conducting the purchase using loyalty points in the user loyalty point account and the borrowed loyalty points; periodically reducing a borrowed loyalty points balance against new loyalty points earned by the user by redeeming the new loyalty points; determining, at the date of the event, a final loyalty points deficiency; and executing a transaction to pay for the final loyalty points deficiency.

In one embodiment, a current loyalty point price for the good or service is less than a future loyalty point price for the good or service on the date of the event.

In one embodiment, the good or service is to be provided at a later date.

In one embodiment, the good or service comprises hotel stay, an airline ticket, or a concert ticket.

In one embodiment, the predicted number of loyalty points that the user will earn is predicted before a cut-off date before the date of the event.

In one embodiment, the loyalty points are borrowed from a loyalty points pool.

In one embodiment, a balance in the user loyalty point account is reduced by a number of borrowed loyalty points.

In one embodiment, the borrowed loyalty points is based on a loyalty points earning history for the user.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for loyalty point borrowing according to an embodiment;

FIGS. 2A and 2B illustrate a method for loyalty point borrowing according to an embodiment; and

FIG. 3 depicts an exemplary computing system for implementing aspects of the present disclosure.

### DETAILED DESCRIPTION OF PREFERRED EMBODIMENTS

Systems and methods for loyalty point borrowing are disclosed.

Embodiments may provide users with a borrowing capability against their loyalty points. For example, a user may make a purchase using X points for a future date using current available points+borrowed points. As that date approaches (e.g., up to the usage date), newly accumulated points may be automatically drawn down against this borrow balance. If the user reaches the usage date or another date (e.g., 1 week before, etc.) and there are insufficient loyalty points available, embodiments may conduct a transaction to purchase the remaining points. The charge may be a credit card charge, an ACH transaction, etc.

Embodiments may use a user's reward earning history to predict whether the user will have sufficient loyalty points by the date they are needed. For example, when the user is presented with the option to borrow loyalty points for a future event, the user may be presented with a prediction as to whether or not the user will have sufficient points by the date. The user may then decide whether or not to borrow points.

In another embodiment, the user may be provided with recommendations for activities that may earn points faster, such as paying a credit card balance before the due date, conducting certain transactions earlier than anticipated, conducting transactions with the points-earning card instead of with a different card, etc.

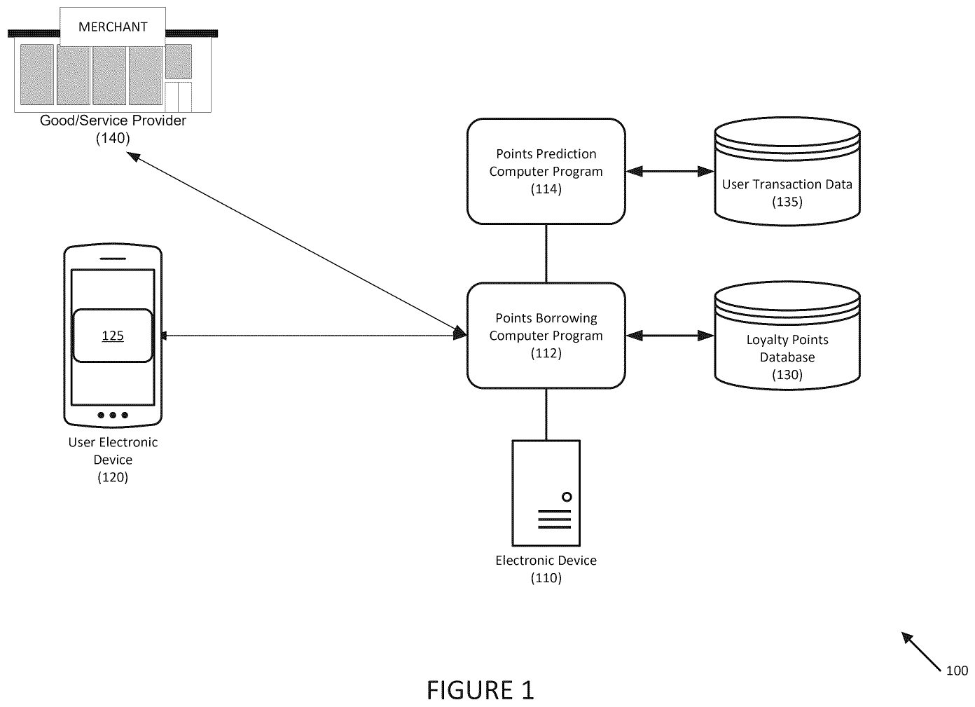

Referring to FIG. 1, a system for loyalty point borrowing is disclosed according to an embodiment. System 100 may include electronic device 110, which may be a server (e.g., physical and/or cloud-based), computers, etc. Electronic device 110 may execute points borrowing computer program 112, which may receive a request from user application 125 executed by user electronic device 120 to conduct a purchase for a good or service for an event that will occur at a future date. The purchase may be with good/service provider 140, such as a good/service provider at which goods/services may be purchased using loyalty points.

In one embodiment a current loyalty point price for the good or service may be less than a future loyalty point price for the good or serve on the future date. For example, airline tickets often require fewer loyalty points when they are purchased in advance of a travel date.

In one embodiment, the user may desire to borrow points without making a specific purchase of a good or service.

User electronic device 120 may be a computer (e.g., a workstation, desktop, laptop, notebook, tablet, etc.), a smart device (e.g., smart phone, smart watch, etc.), an Internet of Things (IoT) appliance, etc.

User application 125 may be provided by a financial institution, FinTech, merchant, etc. with which the user may earn loyalty points and may use the loyalty points for the purchase.

Points borrowing computer program 112 may retrieve a points balance for the user from loyalty points database 130, and may determine if the user has sufficient points to purchase the good or service. If the user does, then the purchase may be conducted, or the loyalty points may be placed in escrow until the event date.

If the user does not have sufficient loyalty points, the points borrowing computer program 112 may use points prediction computer program 114 to predict, based on the user's historical transactions from, for example, user transaction database 135, the user's points balance on the event date or a suitable cut-off date (e.g., 1 week before). Points borrowing computer program 112 may return the prediction to user application 125, and the user may make a determination as to the viability of the purchase.

In one embodiment, because the purchase is conducted with the user's loyalty points and borrowed loyalty points, the purchase price and points needed to conduct the purchase do not change.

In one embodiment, points borrowing computer program 112 may access other accounts that the user may have with the financial institution or FinTech, and may recommend that certain transactions be conducted with the financial instrument that is associated with the points earning behavior. If the user interacts with an aggregator (not shown), points borrowing computer program 112 may receive information on other transactions with other financial instruments that may not be associated with the financial institution or FinTech and may recommend that those transactions be conducted using the financial instrument that is associated with the points earning behavior.

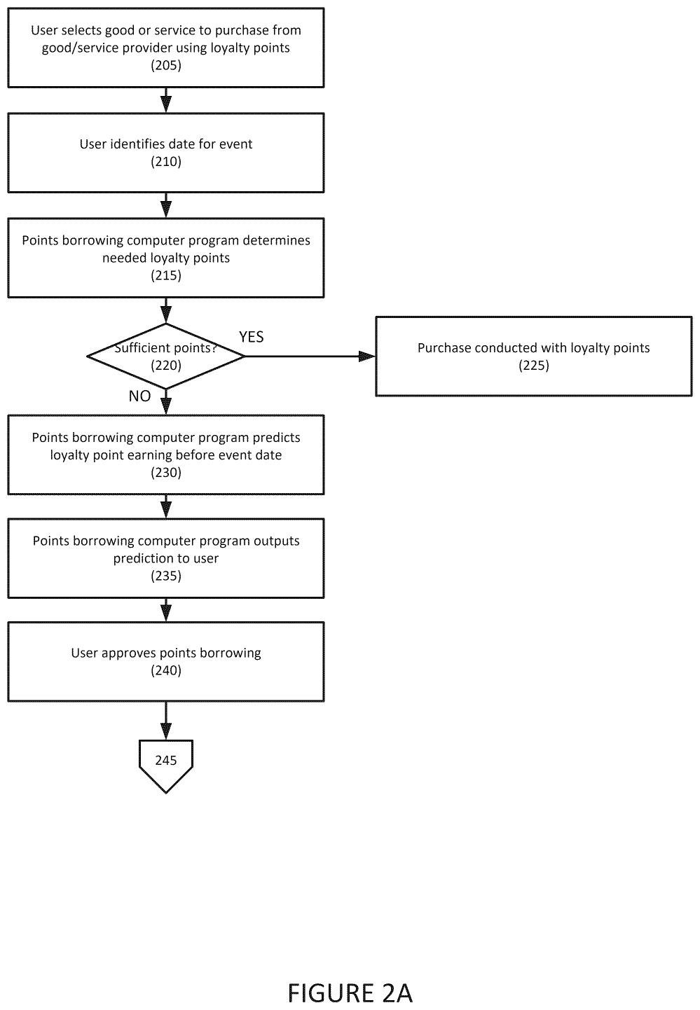

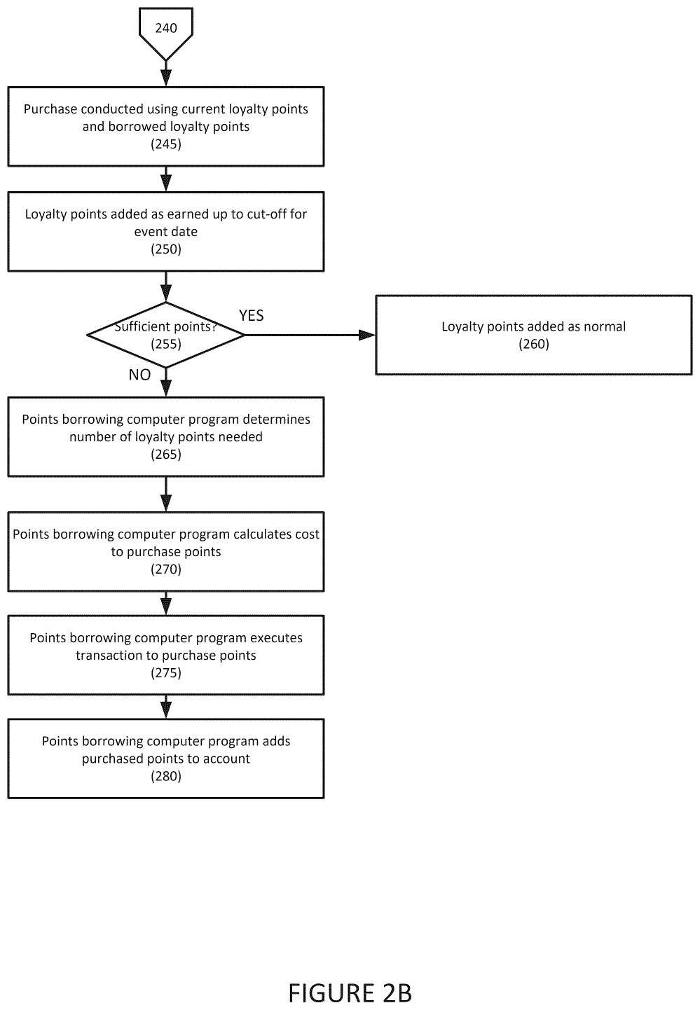

Referring to FIGS. 2A and 2B, a method for loyalty point borrowing is disclosed according to an embodiment.

In step 205, using a user application, a user may select a good or service to purchase from a good/service provider using loyalty points. In one embodiment, the good or service may be a good or service to be provided at a future date, such as a hotel, airline ticket, concert ticket, or a good that the user will receive later. The good/service provider may be an issuer of the loyalty points, or may be affiliated with a loyalty point program for another good/service provider.

In one embodiment, the user may desire to borrow loyalty points independently of a purchase of a good or service. The number of loyalty points that may be borrowed may be based on, for example, the user's historical loyalty point earning. Thus, a user with a higher loyalty point earning history may be able to borrow more loyalty points than a user with a lower loyalty point earning history.

In step 210, if not already provided, the user may identify a date for an event associated with the purchase, such as a travel date, a reservation date, a concert date, etc. The date may be automatically identified (e.g., based on the reservation date, ticket date, etc.).

If the loyalty points are being borrowed independently of the purchase of a good or service, the user may identify a date by which the user intends to “repay” the borrowed points. In one embodiment, the date may be based on the user's historical loyalty point earning.

In step 215, a points borrowing computer program may determine the loyalty points that are needed to purchase the good or service. For example, the points borrowing computer program may determine the number of loyalty points that are required for the purchase, and may also retrieve the user's loyalty points balance.

In step 220, if the user has sufficient loyalty points, in step 225, the purchase may be conducted with the user's loyalty points, and the used loyalty points may be deducted from the user's loyalty point account balance.

If the user does not have sufficient loyalty points, in step 230, the points borrowing computer program may predict the number of loyalty points that the user will earn before the event date or an event cut-off date (e.g., 1 week before the event or any other suitable time).

In step 235, the points borrowing computer program may output the prediction to the user using, for example, the user application. It may further identify the number of points needed for the purchase. In step 240, the user may approve borrowing points for the purchase, and in step 245, the purchase may be conducted using the user's current point balance and any borrowed points.

In one embodiment, the borrowed loyalty points may come from a centralized loyalty points pool that may be provided by the loyalty program provider or operator. In another embodiment, instead of borrowing loyalty points, the user's loyalty point balance may go negative to reflect the “borrowing.”

If the loyalty points are being borrowed independently of a purchase of a good or service, the loyalty points may be transferred to the user's loyalty point account. The user may then use the loyalty points in the user's loyalty point account as desired.

In step 250, as they are earned by the user, loyalty points may be redeemed to reduce the borrowed loyalty points balance, or to decrease the user's negative loyalty points balance.

In step 255, if on the event date or the event cut-off date the user has earned enough points to cover the borrowed loyalty point balance, in step 260, the points may be added as normal.

If the user has not earned enough points to cover the borrowed loyalty points, in step 265, the points borrowing computer program may determine a final points deficiency, e.g., the number of loyalty points needed to zero the borrowed loyalty points balance, or to zero the user's negative loyalty point balance. In step 270, it may then calculate a cost for purchasing the points based on, for example, a cost per point, and in step 275, may execute a transaction to purchase the points.

In one embodiment, the cost for purchasing the points may be based on a conversion rate. The conversion rate may be dynamic and may vary depending on, for example, the number of points needed, the identity/type of good/service provider, etc. In one embodiment, the conversion rate may be set so that the cost of buying the points is consistent with the original cost of purchasing the good/service. For example, the conversion rate may be set so that the cost of buying the points does not exceed the value of the good/service by more than a certain amount. Any suitable conversion rate may be used as is necessary and/or desired.

Once the points are purchased, in step 280, they may be added to the user's point account, so that the balance is zero.

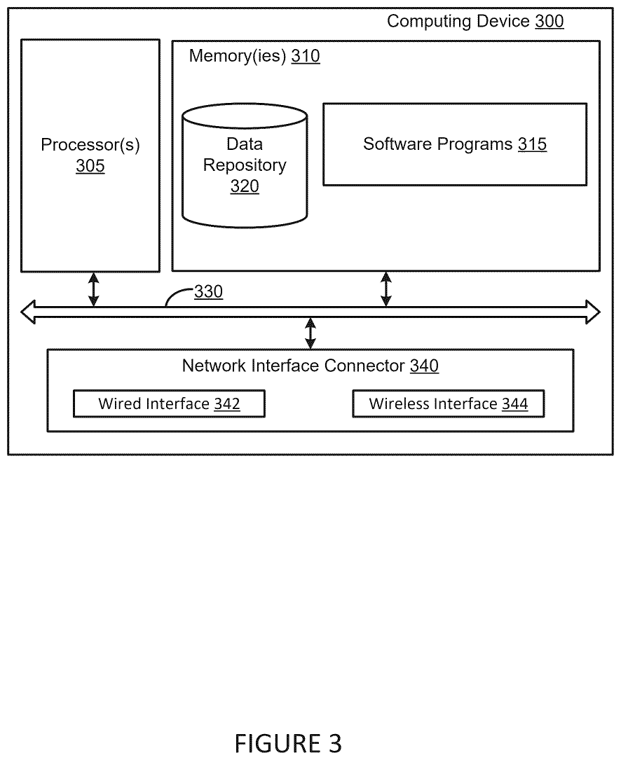

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity, i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a points borrowing computer program and from a user computer program associated with a user, a selection of a good or service to purchase from a good/service provider using loyalty points and an identification of a date for an event associated with a purchase;
determining, by the points borrowing computer program, that the user does not have sufficient loyalty points in a user loyalty point account for the purchase;
predicting, by the points borrowing computer program, a predicted number of loyalty points that the user will earn before the date of the event;
approving, by the points borrowing computer program, the purchase and borrowing loyalty points necessary for the purchase;
conducting, by the points borrowing computer program, the purchase using loyalty points in the user loyalty point account and the borrowed loyalty points;
periodically reducing, by the points borrowing computer program, a borrowed loyalty points balance against new loyalty points earned by the user by redeeming the new loyalty points;
determining, the points borrowing computer program and at the date of the event, a final loyalty points deficiency; and
executing, by the points borrowing computer program, a transaction to pay for the final loyalty points deficiency.

2. The method of claim 1, wherein a current loyalty point price for the good or service is less than a future loyalty point price for the good or service on the date of the event.

3. The method of claim 1, wherein the good or service is to be provided at a later date.

4. The method of claim 1, wherein the good or service comprises hotel stay, an airline ticket, or a concert ticket.

5. The method of claim 1, wherein the points borrowing computer program predicts the predicted number of loyalty points that the user will earn before a cut-off date before the date of the event.

6. The method of claim 1, wherein the loyalty points are borrowed from a loyalty points pool.

7. The method of claim 1, wherein a balance in the user loyalty point account is reduced by a number of borrowed loyalty points.

8. The method of claim 1, wherein a number of the borrowed loyalty points is based on a loyalty points earning history for the user.

9. A method, comprising:
receiving, by a points borrowing computer program and from a user computer program associated with a user, an identification of a number of loyalty points to borrow and a date of repayment for borrowed loyalty points;
predicting, by the points borrowing computer program, a predicted number of loyalty points that the user will earn before the date of repayment;
transferring, by the points borrowing computer program, the borrowed loyalty points to a user loyalty points account;
periodically reducing, by the points borrowing computer program, a borrowed loyalty points balance against new loyalty points earned by the user by redeeming the new loyalty points;
determining, the points borrowing computer program and at the date of the repayment, a final loyalty points deficiency; and
executing, by the points borrowing computer program, a transaction to pay for the final loyalty points deficiency.

10. The method of claim 9, wherein the loyalty points are borrowed from a loyalty points pool.

11. The method of claim 9, wherein a number of the borrowed loyalty points is based on a loyalty points earning history for the user.

12. A non-transitory computer readable storage medium, including instructions stored thereon, which when read and executed by one or more computer processors, cause the one or more computer processors to perform steps comprising:
receiving, from a user computer program associated with a user, a selection of a good or service to purchase from a good/service provider using loyalty points and an identification of a date for an event associated with a purchase;
determining that the user does not have sufficient loyalty points in a user loyalty point account for the purchase;
predicting a predicted number of loyalty points that the user will earn before the date of the event;
approving the purchase and borrowing loyalty points necessary for the purchase;
conducting the purchase using loyalty points in the user loyalty point account and the borrowed loyalty points;
periodically reducing a borrowed loyalty points balance against new loyalty points earned by the user by redeeming the new loyalty points;
determining, at the date of the event, a final loyalty points deficiency; and
executing a transaction to pay for the final loyalty points deficiency.

13. The non-transitory computer readable storage medium of claim 12, wherein a current loyalty point price for the good or service is less than a future loyalty point price for the good or service on the date of the event.

14. The non-transitory computer readable storage medium of claim 12, wherein the good or service is to be provided at a later date.

15. The non-transitory computer readable storage medium of claim 12, wherein the good or service comprises hotel stay, an airline ticket, or a concert ticket.

16. The non-transitory computer readable storage medium of claim 12, wherein the predicted number of loyalty points that the user will earn is predicted before a cut-off date before the date of the event.

17. The non-transitory computer readable storage medium of claim 12, wherein the loyalty points are borrowed from a loyalty points pool.

18. The non-transitory computer readable storage medium of claim 12, wherein a balance in the user loyalty point account is reduced by a number of borrowed loyalty points.

19. The non-transitory computer readable storage medium of claim 12, wherein the borrowed loyalty points is based on a loyalty points earning history for the user.
